(19) United States
(12) Patent Application Publication
(10) Pub. No.: US 2025/0300444 A1
(43) Pub. Date: Sep. 25, 2025

(54) TAMPER-PROOF COLLAR

(71) Applicant: Endress+Hauser SE+Co. KG, Maulburg (DE)

(72) Inventors: Ola Wesstrom, Greenwood, IN (US); Trevor Yenna, Greenwood, IN (US)

(21) Appl. No.: 18/812,191

(22) Filed: Aug. 22, 2024

Related U.S. Application Data
(60) Provisional application No. 63/569,269, filed on Mar. 25, 2024.

(51) Int. Cl. H02G 15/113; H02G 3/06

(52) U.S. Cl. CPC H02G 15/113; H02G 3/0666

(57) ABSTRACT

A collar to provide a tamper-proof cable connection includes two hollow half-cylinders embodied to be brought together to form a complete cylinder about the cable connection. The collar includes a stop structure at each end to prevent the collar from being moved along the cable and away from the connection. A seal may be placed around the collar to prevent the opening of the collar and to provide an inspector's tag.

### CROSS-REFERENCE TO RELATED APPLICATION

The present application is related to and claims the priority benefit of U.S. Provisional Application No. 63/569,269, filed on Mar. 25, 2024, the entire contents of which are incorporated herein by reference.

### TECHNICAL FIELD

The present disclosure relates generally to a collar to prevent manual disconnection of a connected cable.

### BACKGROUND

An industrial process automation system may include a central controller (for example, a programmable logic controller, PLC) and one or more field devices. Some of the field devices in the process automation system may measure something about the automated process such as, for example, a tank fill level, a mass flow through a pipe, or a temperature of a medium. Some of the field devices may control something about the process, such as, for example, a pump state (i.e., on/off), a valve state, or something similar. But all the field devices of the process automation system—regardless of their function—will be in communication with the central controller to measure and to manage the automated process.

The field devices may be connected with the central controller via power and data cables. The power and data connections to the field device may be embodied in a single cable, or they may be embodied in separate cables: one for power, another for data.

To ensure the integrity of the industrial process, the power and data connections to the field device may need to be tamper-proof, or if not tamper-proof, then tamper-evident. That is, once a power and data connection has been made to a field device, it is often necessary to ensure that the power and data connection is not broken. To this end, an inspector of that industrial process automation system may place a tamper-proof seal on that field device, and the seal may include the inspector's credentials.

In applications where the field device is directly wired to the power and data connection (i.e., to a communication bus), a simple seal of the field device ensuring that the field device has not been opened also ensures the field device has not been disconnected from its bus. However, when the field device is connected with the bus via a cable quick-connect (e.g., a screw-on cable connector, a bayonet connector, etc.), a seal—and the inspector's credentials—should be placed on or around the cable quick-connect.

In the state of the art, there remains a need to place tamper-proof protection on a cable quick-connect, wherein the tamper-proof protection accommodates a tag or seal that may include an inspector's credentials.

### SUMMARY

A tamper-proof collar comprises a first half-cylinder having an inner radius, an outer radius, and a height; a second half-cylinder having an inner radius, an outer radius, and a height that are equal to the inner radius, the outer radius, and the height, respectively, of the first half-cylinder; a first loop extending orthogonally from the first half-cylinder along a first lateral edge of the first half-cylinder; a hinge adjoining a second lateral edge of the first half-cylinder and adjoining a first lateral edge of the second half-cylinder, wherein the placement of the hinge enables the first half-cylinder and the second half-cylinder to pivot about the hinge and thereby form a full cylinder; a second loop extending orthogonally from the second half-cylinder along a second lateral edge of the second half-cylinder, wherein the first loop and the second loop coincide when the first half-cylinder and the second half-cylinder are pivoted about the hinge to form the full cylinder; and a first, a second, a third, and a fourth semi-circular stop structure, each stop structure having an inner radius, an outer radius, and a thickness, wherein the outer radius of each stop structure equals the outer radius of the first half-cylinder and wherein the inner radius of each stop structure is less than the inner radius of the first half-cylinder.

The first stop structure may be disposed at a top end of the first half-cylinder, the second stop structure may be disposed at a top end of the second half-cylinder, the third stop structure may be disposed at a bottom end of the first half-cylinder, and the fourth stop structure may be disposed at the bottom end of the second half-cylinder. The first and second stop structures may be so disposed to form a first circular stop structure when the first half-cylinder and the second half-cylinder are pivoted about the hinge to form the full cylinder, and the third and fourth stop structures are so disposed to form a second circular stop structure when the first half-cylinder and the second half-cylinder are pivoted about the hinge to form the full cylinder.

In an embodiment of the tamper-proof collar, the first half-cylinder includes a first plurality of brittle or malleable fins disposed on the first half-cylinder and extending radially from the first half-cylinder, and the second half-cylinder includes a second plurality of brittle or malleable fins disposed on the second half-cylinder and extending radially from the second half-cylinder.

In an embodiment, the tamper-proof collar is embodied of a plastic or a resin, all parts of the tamper-proof collar are embodied together as one piece of the plastic or the resin, and the hinge is embodied as a living hinge.

In an embodiment, the first half-cylinder includes a weep hole disposed through a lateral wall of the first half-cylinder.

In another embodiment, the inner radius of each stop structure is at most 95% of the inner radius of the first half-cylinder.

Another embodiment of a tamper-proof collar comprises a first half-cylinder having an inner radius, an outer radius, and a height, wherein the first half-cylinder includes: a first locking structure extending orthogonally from the first half-cylinder along a first lateral edge of the first half-cylinder; a second locking structure extending orthogonally from the first half-cylinder along a second lateral edge of the first half-cylinder, wherein the first locking structure and the second locking structure each includes a protrusion, a recess, and a through-hole; a first semi-circular stop structure having an inner radius, and outer radius, and a thickness, wherein the first semi-circular stop structure is disposed at a top end of the first half-cylinder; and a second semi-circular stop structure having an inner radius, an outer radius, and a thickness, wherein the second semi-circular stop structure is disposed at a bottom end of the first half-cylinder, wherein the outer radius of the first stop structure and the outer radius of the second stop structure each equals the outer radius of the first half-cylinder, and wherein the inner radius of the first stop structure and the inner radius of the second stop structure each is less than the inner radius of the first half-cylinder; and a second half-cylinder that is identical to the first half-cylinder.

The first locking structure and the second locking structure may be complementary such that the protrusion of the first locking structure corresponds to the recess of the second locking structure, the recess of the first locking structure corresponds to the protrusion of the second locking structure, and the through-hole of the first locking structure corresponds to the through-hole of the second locking structure. The first half-cylinder and the second half-cylinder may be embodied to form a complete cylinder in which the first locking structure of the first half-cylinder engages the second locking structure of the second half-cylinder, the second locking structure of the first half-cylinder engages the first locking structure of the second half-cylinder, and the through-holes of the locking structures of the first half-cylinder coincide with the corresponding through-holes of the locking structures of the second half-cylinder.

In an embodiment of the tamper-proof collar, the first half-cylinder and the second half-cylinder each includes a weep hole disposed through a lateral wall of the respective half-cylinder.

In another embodiment of the tamper-proof collar, the first half-cylinder includes a first plurality of brittle or malleable fins disposed on the first half-cylinder and extending radially from the first half-cylinder, and the second half-cylinder includes a second plurality of brittle or malleable fins disposed on the second half-cylinder and extending radially from the second half-cylinder.

In another embodiment of the tamper-proof collar, the first half-cylinder and the second half-cylinder with their respective locking structures are embodied of metal.

In another embodiment of the tamper-proof collar, the first half-cylinder and the second half-cylinder with their respective locking structures and fins are embodied of metal.

In another embodiment of the tamper-proof collar, the inner radius of the first stop structure and the inner radius of the second stop structure each is no more than 95% of the inner radius of the first half-cylinder.

### BRIEF DESCRIPTION OF THE DRAWINGS

FIG. 1 shows an embodiment of a one-piece tamper-proof collar.

FIG. 2 shows an embodiment of a one-piece tamper-proof collar with fins.

FIG. 3 shows an embodiment of a two-piece tamper-proof collar.

FIG. 4 shows an embodiment of a two-piece tamper-proof collar with fins.

FIG. 5 shows a tamper-proof collar disposed around a cable end attached to a field device.

### DETAILED DESCRIPTION

Disclosed is a collar embodied to be placed around, i.e., enclose, a cable quick-connect such that the cable quick-connect cannot be disconnected (from that thing to which it is connected) without first destroying the collar. The collar thus makes the connection of the cable quick-connect tamper-proof. The collar is embodied to be closed using an inspector's seal as proof of the integrity of the attachment of the cable quick connect.

The collar is embodied to cover the knurling or hexagonal structure (or similar external structure) that is provided on the cable quick-connect for the manual connecting and disconnecting of the quick-connect. The collar is embodied large enough to turn freely around the quick-connect, yet the design of the collar prevents the collar from being moved along the cable and away from the quick-connect.

The tamper-proof collar is not designed to be indestructible, but rather it is designed to be closed, and sealed, and not opened again without the breaking of the seal or the breaking of the collar. It is in this manner the collar provides the tamper-proof connection: the collar makes evident any attempts of tampering with the cable connection.

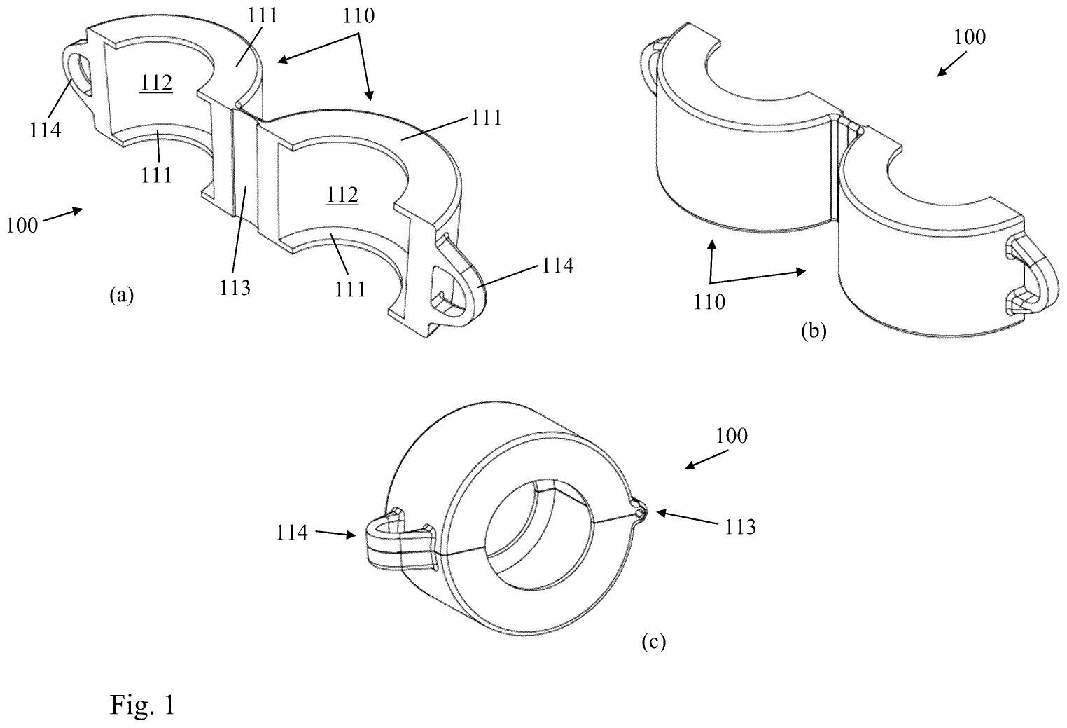

An embodiment of a tamper-proof collar 100 is shown in FIG. 1. The collar 100 may be made from two half cylinders 110 attached together via a hinge 113. The collar 100 as shown in FIG. 1 may be embodied in one piece of a plastic or similar material. Such a collar 100 may be formed by injection molding or by an additive manufacturing process (e.g., 3D printing). In this one-piece embodiment of the collar 100, the material of the collar 100 with its living hinge 113 must be flexible enough and resilient enough to allow the working of the hinge 113.

Each half cylinder 110 of the collar 100 may be formed by a semi-circular half cylinder wall 112 having attached at two ends a stop structure 111. The stop structures 111 may be semi-circular. The half cylinders 110 are embodied with a diameter large enough to allow the closed collar 100 to move freely about the cable quick-connect. The stop structures 111 may be embodied with an inner diameter large enough to fit around the cable but small enough to prevent the collar 100 from being moved along the cable and away from the quick-connect. That is, the inner diameter of the stop structures 111 may be smaller than the outer diameter of the cable quick-connect around which the collar 100 may be disposed.

Extending outwardly, orthogonally, from each half cylinder 110 may be a closed loop 114. When the two half cylinders 110 are folded together about the hinge 113 to form the collar 100, the loops 114 of each half cylinder 110 may meet and coincide. The folded over half cylinders 110 with the meeting, coinciding loops 114 is shown in FIG. 1(c). Through the coinciding closed loops 114 an inspector's seal may be placed to close the half-cylinders together. With the inspector's seal in place, the collar 100 may not be opened without cutting/breaking the inspector's seal or without cutting/breaking the collar 100 itself. That is, what the inspector has joined no one may put asunder.

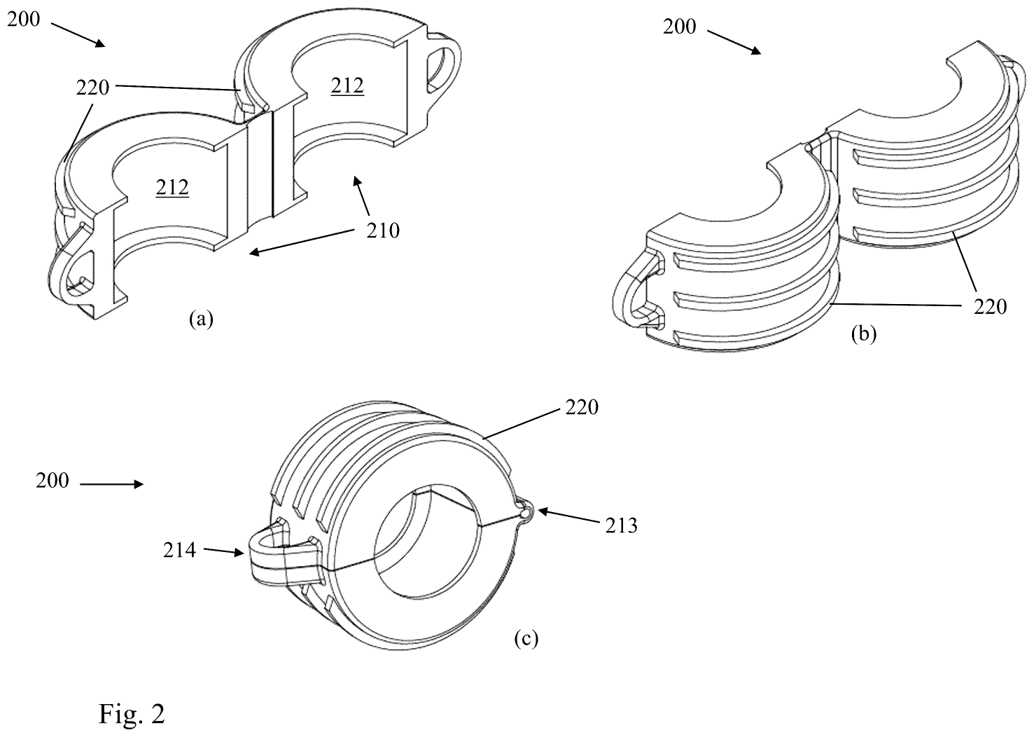

A second embodiment of the tamper-proof collar 200 is shown in FIG. 2. The structure of the collar 200 in FIG. 2 may be identical to that of the collar 100 in FIG. 1 but for the addition of fin structures 220. The fins 220 may be embodied as small, thin protrusions extending outwardly from the walls 212 of the half cylinders 210. The fins 220 may be embodied of the same material as that of the half cylinders 210 and may be embodied in the same process that forms the half cylinders 210.

The fins 220 may be embodied to be easily damaged. Therefore, the fins 220 may be thin and sufficiently tall to easily damage when gripped with pliers or some other tool in an attempt to manipulate the cable quick-connect. The number of fins 220 may depend on the length of the collar 200 (i.e., the height of the half cylinders 210). The fin placement must leave no room for a tool to grip the collar 200.

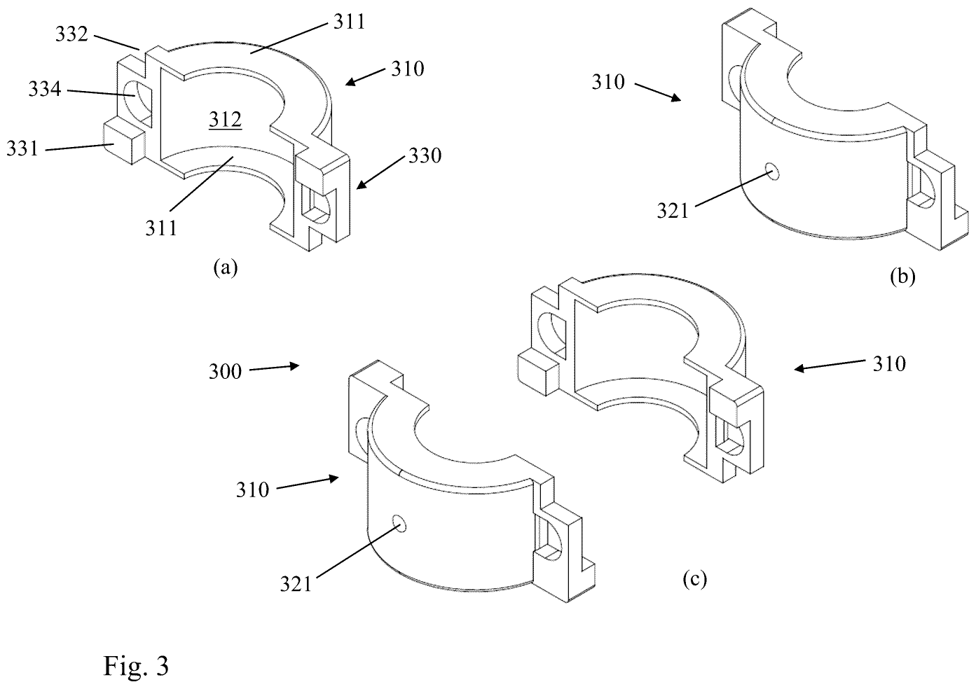

FIG. 3 shows a third embodiment of a tamper-proof collar 300 according to the present disclosure. Unlike the collars shown in FIGS. 1 and 2, the collar 300 as shown in FIG. 3 is formed from two distinct and separate half cylinders 310. No hinge is present in this particular embodiment of the collar 300.

The half cylinders 310 that form the collar 300 may be identical. Though identical, the half cylinders 310 may include a locking structure 330 that is complementary with itself. That is to say, the locking structure 330 may be embodied to mate, to interlock, with a second and identical locking structure 330 when two half cylinders 310 are brought together.

Details of the locking structure 330 may be seen in FIG. 3(a). The locking structure 330 may include a recess 332 and a tab 331, and the recess 332 and tab 331 may be sized and may be positioned on the locking structure 330 to closely mate when two half cylinders 310 are brought together. FIG. 3(c) shows a perspective view of two half cylinders 310 of the collar 300 positioned facing each other. This view of FIG. 3(c) shows how the recess 332 and tab 331 are embodied to mate with each other, and further shows how the closed loops 334 of the locking structures 330 will coincide when the two half cylinders are put together.

As with the embodiments of the collar as shown in FIGS. 1 and 2, the collar 300 may include stop structures 311 to prevent the closed collar 300 from being moved along a cable and away from the quick-connect around which the collar 300 may have been closed.

The half cylinders 310 of the collar 300 may additionally include a weep hole 321 to allow the escape of any liquid that may have entered the collar.

When the two half cylinders 310 of the collar 300 are brought together and mated over a cable quick-connect, each of the two closed-loop pairs 334 must be closed with an inspector's seal or similar closure. Alternately, a single seal may be run around the collar 300 and though the two pairs of closed-loops 334 to close and seal the collar.

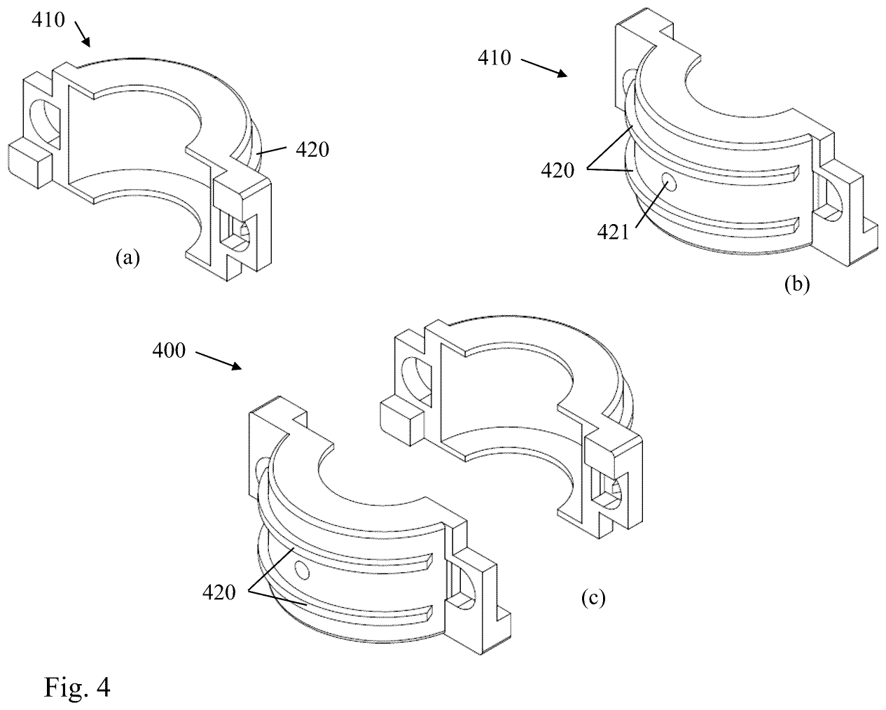

FIG. 4 shows a fourth embodiment of a tamper-proof collar 400 according to the present disclosure. The collar 400 as shown in FIG. 4 is the same as that as shown in FIG. 3 but for the fins 420. The fins 420, like the fins 220 as shown in FIG. 2, are embodied to be easily damaged and to provide evidence of attempted tampering of the cable quick-connect. Though two fins 420 are shown in FIG. 4, more may be used; the number of fins 420 will depend on the height of the collar 400.

In all embodiments of the tamper-proof collar, the insides of the half cylinder wall should be smooth and without any structure (such as dimples, projections, etc.) that would allow the collar itself to be used to grip the quick-connect and thereby manipulate the quick connect.

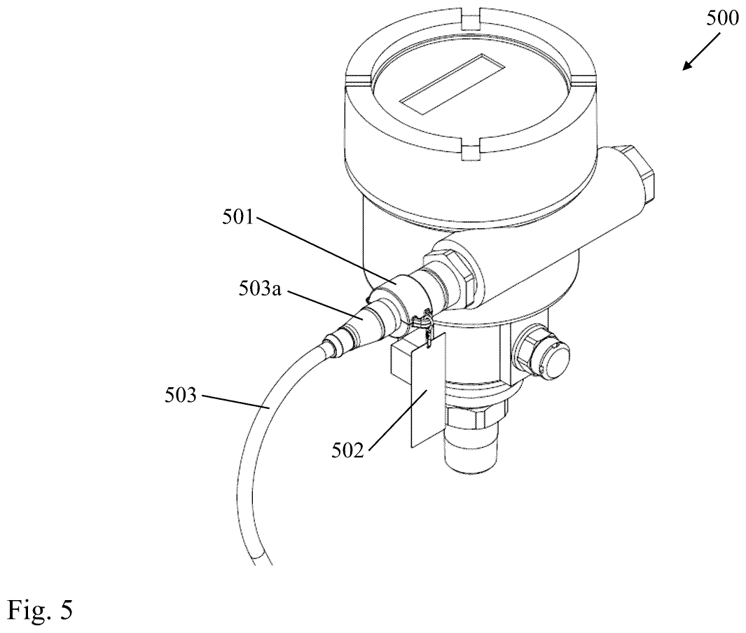

FIG. 5. shows a field device 500 connected with a cable 503. The cable 503 may provide a power connection or a data connection or, more likely, a power and data connection to the field device 500. The cable 503 has a cable end 503a that is enclosed by a tamper-proof collar 501. Attached to the tamper-proof collar 501 is an inspector's tag 502 has been attached through the loops of the closed collar 501.

What is claimed is:

1. A tamper-proof collar, comprising:
a first half-cylinder having an inner radius, an outer radius, and a height;
a second half-cylinder having an inner radius, an outer radius, and a height that are equal to the inner radius, the outer radius, and the height, respectively, of the first half-cylinder;
a first loop extending orthogonally from the first half-cylinder along a first lateral edge of the first half-cylinder;
a hinge adjoining a second lateral edge of the first half-cylinder and adjoining a first lateral edge of the second half-cylinder, wherein the placement of the hinge enables the first half-cylinder and the second half-cylinder to pivot about the hinge and thereby form a full cylinder;
a second loop extending orthogonally from the second half-cylinder along a second lateral edge of the second half-cylinder, wherein the first loop and the second loop coincide when the first half-cylinder and the second half-cylinder are pivoted about the hinge to form the full cylinder; and
a first, a second, a third, and a fourth semi-circular stop structure, each stop structure having an inner radius, an outer radius, and a thickness, wherein the outer radius of each stop structure equals the outer radius of the first half-cylinder and wherein the inner radius of each stop structure is less than the inner radius of the first half-cylinder;
wherein the first stop structure is disposed at a top end of the first half-cylinder, the second stop structure is disposed at a top end of the second half-cylinder, the third stop structure is disposed at a bottom end of the first half-cylinder, and the fourth stop structure is disposed at a bottom end of the second half-cylinder,
wherein the first and second stop structures are so disposed to form a first circular stop structure when the first half-cylinder and the second half-cylinder are pivoted about the hinge to form the full cylinder, and
wherein the third and fourth stop structures are so disposed to form a second circular stop structure when the first half-cylinder and the second half-cylinder are pivoted about the hinge to form the full cylinder.

2. The tamper-proof collar of claim 1,
wherein the first half-cylinder includes a first plurality of brittle or malleable fins disposed on the first half-cylinder and extending radially outward from the first half-cylinder, and
wherein the second half-cylinder includes a second plurality of brittle or malleable fins disposed on the second half-cylinder and extending radially outward from the second half-cylinder.

3. The tamper-proof collar of claim 2,
wherein the tamper-proof collar is embodied of a plastic or a resin,
wherein all parts of the tamper-proof collar are embodied together as one piece of the plastic or the resin, and
wherein the hinge is embodied as a living hinge.

4. The tamper-proof collar of claim 1,
wherein the first half-cylinder includes a weep hole disposed through a lateral wall of the first half-cylinder.

5. The tamper-proof collar of claim 1,
wherein the inner radius of each stop structure is at most 95% of the inner radius of the first half-cylinder.

6. A tamper-proof collar, comprising:
a first half-cylinder having an inner radius, an outer radius, and a height, wherein the first half-cylinder includes:
a first locking structure extending orthogonally from the first half-cylinder along a first lateral edge of the first half-cylinder;
a second locking structure extending orthogonally from the first half-cylinder along a second lateral edge of the first half-cylinder, wherein the first locking structure and the second locking structure each includes a protrusion, a recess, and a through-hole;
a first semi-circular stop structure having an inner radius, and outer radius, and a thickness, wherein the first semi-circular stop structure is disposed at a top end of the first half-cylinder; and
a second semi-circular stop structure having an inner radius, an outer radius, and a thickness, wherein the second semi-circular stop structure is disposed at a bottom end of the first half-cylinder, wherein the outer radius of the first stop structure and the outer radius of the second stop structure each equals the outer radius of the first half-cylinder, and wherein the inner radius of the first stop structure and the inner radius of the second stop structure each is less than the inner radius of the first half-cylinder; and
a second half-cylinder that is identical to the first half-cylinder,
wherein the first locking structure and the second locking structure are complementary such that the protrusion of the first locking structure corresponds to the recess of the second locking structure, the recess of the first locking structure corresponds to the protrusion of the second locking structure, and the through-hole of the first locking structure corresponds to the through-hole of the second locking structure, and
wherein the first half-cylinder and the second half-cylinder are embodied to form a complete cylinder in which the first locking structure of the first half-cylinder engages the second locking structure of the second half-cylinder, the second locking structure of the first half-cylinder engages the first locking structure of the second half-cylinder, and the through-holes of the locking structures of the first half-cylinder coincide with the corresponding through-holes of the locking structures of the second half-cylinder.

7. The tamper-proof collar of claim 6,
wherein the first half-cylinder and the second half-cylinder each includes a weep hole disposed through a lateral wall of the respective half-cylinder.

8. The tamper-proof collar of claim 6,
wherein the first half-cylinder includes a first plurality of brittle or malleable fins disposed on the first half-cylinder and extending radially outward from the first half-cylinder, and
wherein the second half-cylinder includes a second plurality of brittle or malleable fins disposed on the second half-cylinder and extending radially outward from the second half-cylinder.

9. The tamper-proof collar of claim 6,
wherein the first half-cylinder and the second half-cylinder with their respective locking structures are embodied of metal.

10. The tamper-proof collar of claim 8,
wherein the first half-cylinder and the second half-cylinder with their respective locking structures and fins are embodied of metal.

11. The tamper-proof collar of claim 6,
wherein the inner radius of the first stop structure and the inner radius of the second stop structure each is no more than 95% of the inner radius of the first half-cylinder.
